(19) United States
(12) Patent Application Publication
(10) Pub. No.: US 2023/0052597 A1
(43) Pub. Date: Feb. 16, 2023

(54) METHOD FOR TRANSMITTING AND RECEIVING A MESSAGE INCLUDING AN ENCRYPTED IDENTIFIER OF THE TRANSMITTER DEVICE

(71) Applicant: SIGFOX, LABEGE (FR)

(72) Inventor: Florian EUCHNER, Nürtingen (FR)

(21) Appl. No.: 17/789,348

(22) PCT Filed: Jan. 7, 2021
(86) PCT No.: PCT/EP2021/050198

§ 371 Date: Jun. 27, 2022

(30) Foreign Application Priority Data
Jan. 9, 2020 (FR) FR2000184

(51) Int. Cl. H04L 9/40; H04L 9/08; H04L 9/14

(52) U.S. Cl. CPC H04L 63/0435; H04L 9/0866; H04L 9/14

(57) ABSTRACT

In a digital communication system, using a symmetric key encryption protocol, the identifier of a transmitter included in a message transmitted to a receiver is encrypted. The identifier is divided into P parts, P being an integer number at least equal to two. The parts are ordered and associated, respectively, with ranks varying between one and P. For at least one part of rank greater than or equal to two, an encryption key is determined on the basis of the values of the parts of preceding rank and is encrypted with the encryption key thus determined. An encrypted identifier is then determined from the one or more encrypted parts thus obtained. The message to be transmitted is then formed from the encrypted identifier thus determined, and then transmitted to the receiver.

### FIELD OF INVENTION

The present invention belongs to the field of digital communications. In particular, the invention relates to a method for transmitting and a method for receiving a message including an encrypted identifier of the device which transmits the message. The invention also relates to the transmitter device and the receiver device which implement, respectively, this transmission method and this reception method.

### STATE OF THE ART

The present invention finds a particularly advantageous application, although without limitation, in communication systems for connected objects (communication system for the Internet of Things—IoT—or for machine-to-machine M2M communication). In such communication systems, it is often required to secure the exchanged messages by encryption. However, it is also required to limit the size of the exchanged messages in order to limit the power consumption of the transmitter devices and/or to optimise the radio resources of the communication system. Also, it is desirable to limit the complexity and the processing time of the operations to be performed for the encryption at the transmitter devices.

Conventionally, a message exchanged between a transmitter device and a receiver device includes an identifier of the transmitter device, such that the receiver device can identify which transmitter device transmitted the message.

The authentication of a message exchanged between a transmitter device and a receiver device is generally ensured by a message authentication code (or MAC) which is calculated using a Network Authentication Key (or NAK) and possibly other data such as the useful data contained in the message or a message counter for which a synchronisation is maintained between the transmitter device and the receiver device. The authentication key is known by both the transmitter device and the receiver device. The authentication code calculated by the transmitter device is included in the message. It can therefore be checked by the receiver device to authenticate the message.

A malicious person who would like to send a message with a particular identifier as if said message had been sent by the transmitter device associated with said identifier should try several possible values of the authentication code until they stumble upon the proper value. Although potentially a very large number of possible values of the authentication code would have to be tried, this is not possible.

In order to improve the security, it is possible to encrypt the identifier depending on an encryption key and possibly depending on other data available both for the transmitter device and for the receiver device. Thus, the malicious person should not only find the proper authentication code value, but also the correct encryption to apply to the identifier. The problem which then arises is to know how to encrypt the identifier.

Asymmetric cryptography is generally not well suited for IoT or M2M type systems. Indeed, the processing times for encryption are relatively long and, for a given level of security, the keys to be used are much longer than for the symmetric cryptography.

The symmetric cryptography, however, is much better suited to IoT or M2M type systems. The symmetric cryptography, nevertheless, requires an encryption key which must be known by both the transmitter device and the receiver device. It is not reasonable to use the same encryption key for all transmitter devices because this amounts to making the key public (it would become possible to discover this encryption key for example by disassembling the computer code of a transmitter device). It is also not possible to associate an encryption key with each transmitter device, because the receiver device would not know which key to use in order to decrypt the identifier contained in a message that it received from a transmitter device.

### OBJECT AND SUMMARY OF THE INVENTION

The present invention aims at overcoming all or part of the drawbacks of the prior art, in particular those set out above.

To this end, and according to a first aspect, the present invention proposes a method for transmitting a message, by a transmitter device of a communication system, to a receiver device of said communication system. The transmission method includes:
a division of an identifier of the transmitter device into an integer number P of parts at least equal to two, said parts being ordered and associated, respectively, with ranks varying between one and P,
for at least one part of rank which is greater than or equal to two, a determination of an encryption key depending on the values of the parts of preceding rank and an encryption of said part with the encryption key thus determined, the encryption being performed according to a symmetric key encryption protocol,
a determination of an encrypted identifier from the encrypted part(s) thus obtained,
a formation of the message to be transmitted from the encrypted identifier,
a transmission of the message.

The term “an identifier of the transmitter device” means the smallest information item allowing uniquely identify the transmitter device among all transmitter devices of the communication system.

Conventionally, the identifier is usually encoded on a bit field. A value taken by the identifier is therefore a value comprised between 0 and (2^{N}−1), where N is a positive integer number corresponding to the number of bits encoding the identifier. In such a case, it is possible to uniquely identify 2^{N} different transmitter devices belonging to the communication system.

Each part of the identifier can then for example be encoded on Nₖ bits, where Nₖ is a positive integer number which is strictly less than N, and k is an index of said part varying between one and P (1≤k≤P). The value of a part of the identifier of index k therefore varies between 0 and (2^{N}−1). Also, the following relation is satisfied: Σₖ₌₁^{k=P} Nₖ=N.

In the present application, the term “part” is used to designate an unencrypted part of an identifier. When considering the result of the encryption of a part of the identifier, the term “encrypted part” is used.

With such arrangements, and as will be detailed later, the receiver device will be able to discover as the identifier is decrypted, which keys to use in order to completely decrypt the identifier. Indeed, it is sufficient for the receiver device to know how to decrypt the part (encrypted or not) of rank one in order to then be able to successively determine the encryption keys which must be used to decrypt the encrypted parts of rank which is greater than or equal to two.

It should be noted that, obviously, in the case where the identifier which is included, after encryption, in the message is an essential information item to allow identifying the transmitter device having transmitted said message (a transmitter device of the system is uniquely identified by a value of the identifier). It is also considered that, in addition to the encrypted identifier, the message does not contain any other indication allowing determining an encryption key allowing decrypting the encrypted identifier.

The fact of determining an encryption key to encrypt a part of a given rank depending on the values of the unencrypted parts of preceding rank is particularly advantageous since it is then sufficient, for a given transmitter device, to store only the encryption keys necessary to encrypt its identifier (there are at most P), and these will always remain valid, even if the encryption algorithm of the symmetric key encryption protocol changes over time (in other words, it does not is not necessary to update the encryption keys of a transmitter device if the encryption algorithm is updated).

In particular implementations, the invention may further include one or more of the following features, taken in isolation or in all technically possible combinations.

In particular implementations, the encryption is performed on all parts of rank greater than or equal to two. Such arrangements allow reinforcing the security of the encryption of the identifier.

In particular implementations, the determination of the encrypted identifier includes an encryption of the part of rank one with an identical encryption key for a plurality of transmitter devices of the system, and a concatenation of the encrypted parts of rank one to P.

The term “a plurality of transmitter devices of the system” means at least one part of all transmitter devices of the communication system (this is the case in particular if only a part of the transmitter devices of the system uses an encryption of the identifier according to the invention). However, nothing prevents said plurality of transmitter devices from corresponding to the set of all transmitter devices of the system.

With such arrangements, the receiver device knows how to decrypt the rank one encrypted part since it knows the encryption key to be used.

In particular implementations, the determination of the encrypted identifier includes a concatenation of the unencrypted part of rank one with the encrypted parts of rank two to P.

With such arrangements, the receiver device does not need to decrypt the encrypted part of rank one since it is not encrypted.

In particular implementations, each part includes a single bit of a bit field corresponding to the identifier of the transmitter device.

In particular implementations, the encryption keys which are determined depending on the values of the parts of an identifier are all different from each other.

Indeed, such arrangements allow reinforcing the security of the encryption of the identifier.

According to a second aspect, the present invention relates to a computer program product which includes a set of program code instructions which, when executed by one or more processors, configure the processor(s) to implement a transmission method according to any one of the preceding implementations.

According to a third aspect, the present invention relates to a transmitter device of a communication system to transmit a message to a receiver device of said communication system. The transmitter device includes a processing circuit configured for:
dividing an identifier of the transmitter device into a hole number P of parts at least equal to two, said parts being ordered and associated respectively with ranks varying between one and P,
for at least one part of rank which is greater than or equal to two, determining an encryption key depending on the values of the parts of preceding rank, and encrypting said part with the encryption key thus determined, the encryption being performed according to a symmetric key encryption protocol,
determining an encrypted identifier from the encrypted part(s) thus obtained,
forming a message to be transmitted from the encrypted identifier,
transmitting the message to the receiver device.

In particular embodiments, the invention may further include or more of the following features, taken in isolation or in all technically possible combinations.

In particular implementations, in order to determine the encrypted identifier, the part of rank one is encrypted with an identical encryption key for a plurality of transmitter devices of the system, and the encrypted parts of rank one to P are concatenated.

In particular embodiments, the processing circuit is configured to encrypt all parts of rank greater than or equal to two.

In particular embodiments, in order to determine the encrypted identifier, the unencrypted part of rank one is concatenated with the encrypted parts of rank two to P.

In particular embodiments, each part includes a single bit of a bit field corresponding to the identifier of the transmitter device.

In particular embodiments, the encryption keys which are determined depending on the values of the parts of an identifier are all different from each other.

According to a fourth aspect, the present invention relates to a method for receiving, by a receiver device of a communication system, a message transmitted by a transmitter device of said communication system in accordance with a transmission method according to any one of the preceding implementations.

The reception method includes:
an extraction of the encrypted identifier of the received message,
a division of the encrypted identifier into the P parts,
for at least one encrypted part of rank which is greater than or equal to two, a determination of an encryption key depending on the values of the unencrypted or decrypted parts of preceding rank, and a decryption of said encrypted part, the decryption being performed according to the symmetric key encryption protocol used by the method for transmitting the message,
a determination of the identifier of the transmitter device from the decrypted part(s) thus obtained.

Thus, the receiver device discovers, as the identifier is decrypted, which keys to use in order to completely decrypt the identifier. It is therefore sufficient for the receiver device to know how to decrypt the part (encrypted or not) of rank one in order then to be able to successively determine the encryption keys which must be used to decrypt the encrypted parts of rank which is greater than or equal to two.

It should be noted that the encryption protocol may possibly be different for different parts of the identifier. However, for a given part, the same encryption protocol is used by the transmission method and by the reception method.

The term “Encryption protocol” means a protocol allowing encrypting an unencrypted data item and decrypting an encrypted data item by this protocol.

In particular implementations, the decryption is performed on all parts of rank which is greater than or equal to two.

In particular implementations, the part of rank one of the identifier of the transmitter device has been encrypted by the method for transmitting the message with an identical encryption key for a plurality of transmitter devices of the communication system, and the determination of the identifier of the transmitter device includes a decryption of the encrypted part of rank one with said identical encryption key for the plurality of transmitter devices of the system, and a concatenation of the decrypted parts of rank one to P.

In particular embodiments, the part of rank one of the identifier of the transmitter device was transmitted unencrypted, and the determination of the identifier of the transmitter device includes a concatenation of the unencrypted part of rank one with the decrypted parts of rank two to P.

According to a fifth aspect, the present invention relates to a computer program product including a set of program code instructions which, when executed by one or more processors, configure the processor(s) to implement a reception method according to any one of the preceding implementations.

According to a sixth aspect, the present invention relates to a receiver device of a communication system for receiving a message transmitted by a transmitter device of said communication system in accordance with a transmission method according to any one of the preceding implementations. The receiver device includes a processing circuit configured for:
extracting the encrypted identifier of the received message,
dividing the encrypted identifier into the P parts,
for at least one encrypted part of rank which is greater than or equal to two, determining an encryption key depending on the values of the unencrypted or decrypted parts of preceding rank, the decryption being performed according to the symmetric key encryption protocol used by the method for transmitting the message,
determining the identifier of the transmitter device from the decrypted part(s) thus obtained.

In particular embodiments, the processing circuit is configured to decrypt all parts of rank greater than or equal to two.

In particular embodiments, the part of rank one of the identifier of the transmitter device has been encrypted by the method for transmitting the message with an identical encryption key for a plurality of transmitter devices of the communication system and, in order to determine the identifier of the transmitter device, the encrypted part of rank one is decrypted with said identical encryption key for the plurality of transmitter devices of the system and the decrypted parts of rank one to P are concatenated.

In particular embodiments, the part of rank one of the identifier of the transmitter device was transmitted unencrypted and, in order to determine the identifier of the transmitter device, the unencrypted part of rank one is concatenated with the decrypted parts of rank two to P.

### BRIEF DESCRIPTION OF THE FIGURES

The invention will be better understood on reading the following description, given by way of non-limiting example, and made with reference to FIGS. 1 to 10 which represent:

FIG. 1 is a schematic representation of the encryption of an information item by a symmetric key encryption protocol,

FIG. 2 is a schematic representation of the decryption of an information item by a symmetric key encryption protocol,

FIG. 3 is a schematic representation of the transmission of a message by a transmitter device to a receiver device,

FIG. 4 is a schematic representation of the main steps of a method for transmitting a message according to the invention,

FIG. 5 is a schematic representation of a division of an identifier into several parts each including several bits,

FIG. 6 is a schematic representation of a division of an identifier into several parts each including a single bit,

FIG. 7 is a schematic representation of the encryption, by a transmitter device, of an identifier including four parts each including a single bit,

FIG. 8 is a schematic representation of the main steps of a method for receiving a message according to the invention,

FIG. 9 is a schematic representation of the encryption keys determined respectively depending on the values of the parts of an identifier,

FIG. 10 is a schematic representation of the decryption, by a receiver device, of the encrypted identifier as illustrated in FIG. 7.

In these figures, identical references from one figure to another designate identical or similar elements. For reasons of clarity, the represented elements are not necessarily to the same scale, unless otherwise stated.

### DETAILED DESCRIPTION OF AN EMBODIMENT OF THE INVENTION

As previously indicated, the present invention aims at encrypting the identifier of a transmitter device of a communication system with a symmetric key encryption protocol using different encryption keys for different transmitter devices of the system.

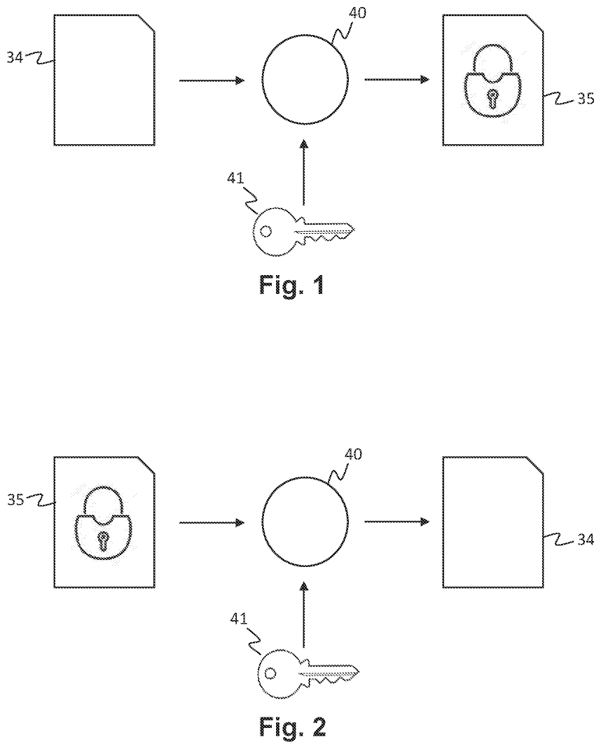

FIGS. 1 and 2 represent, respectively, the encryption and decryption of an information item 34 by a symmetric key encryption protocol 40. The encryption key 41 used during encryption (FIG. 1) and the encryption key 41 used during decryption (FIG. 2) must be identical. The information item 34 to be encrypted corresponds for example to a field of bits. The symmetric key encryption protocol 40 uses for example a symmetric encryption algorithm such as AES (acronym for “Advanced Encryption Standard”). Conventionally, for encryption, the algorithm takes as input the information item 34 to be encrypted, the encryption key 41, and possibly other data known both by the entity performing the encryption and the entity performing the decryption, and outputs an encrypted information item 35. For the decryption, the algorithm allows decrypting the encrypted information 35 using the encryption key 41 and, where applicable, other data used during the encryption, in order to obtain the original unencrypted information item 34.

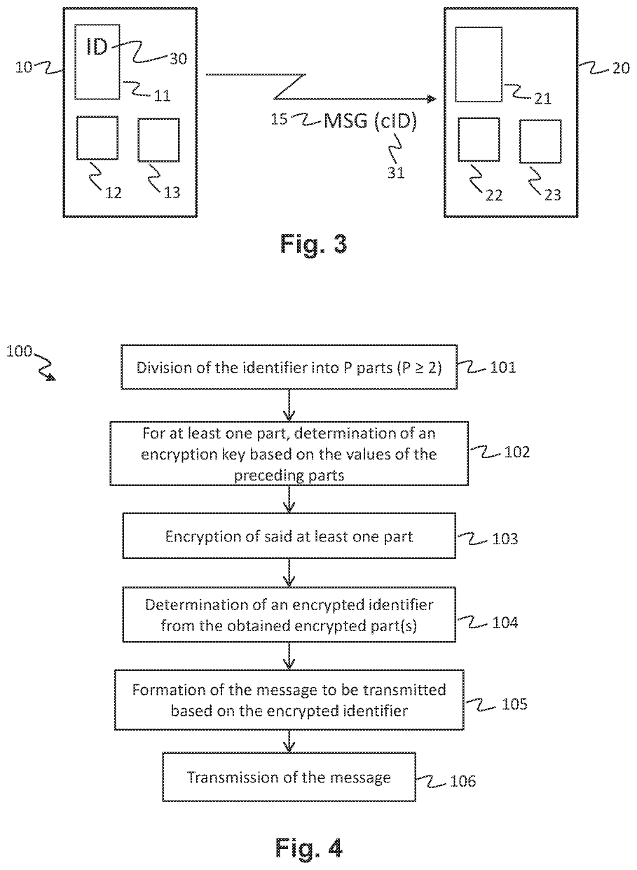

FIG. 3 schematically represents the sending of a message 15, by a transmitter device 10 of a communication system, to a receiver device 20 of said system. An identifier 30 is associated with the transmitter device 10. The identifier 30 is for example stored within a memory of the transmitter device 10. The identifier 30 (ID) is encrypted by a symmetric key encryption protocol 40, and the encrypted identifier 31 (cID) is included in the message 15.

As already previously mentioned, it is undesirable to use the same encryption key for all transmitter devices in the system, because this amounts to making the key public and it would not make sense in terms of security. It is also not possible to simply associate an encryption key with each transmitter device 10, because the receiver device 20 would not know which key to use in order to decrypt the encrypted identifier 31 contained in a message that it would have received from a transmitter device 10.

FIG. 4 represents the main steps of a transmission method 100 for transmitting a message by a transmitter device 10 to a receiver device 20. The transmission method 100 is implemented by the transmitter device 10. In For this purpose, and as illustrated in FIG. 3, the transmitter device 10 includes a memory 11, one or more processors 12 and a communication module 13. A computer program is stored in a non-volatile manner in the memory 11 of the transmitter device 10. The computer program includes a set of program code instructions which, when executed by the processor(s) 12, configure the processor(s) 12 to implement a transmission method 100 according to the invention. Alternatively or in addition, the transmitter device 10 includes one or more programmable logic circuits (FPGA, PLD, etc.), and/or one or more specialised integrated circuits (ASIC), and/or a set of discrete electronic components, etc., adapted to implement all or part of the steps of the transmission method 100 according to the invention. In other words, the transmitter device 10 includes means which are software configured (specific computer program product) and/or hardware configured (FPGA, PLD, ASIC, discrete electronic components, etc.) to implement the steps of the transmission method 100 according to the invention.

As illustrated in FIG. 4, the transmission method 100 includes a division 101 of the identifier 30 of the transmitter device 10 into an integer number P of parts at least equal to two. The parts are ordered and associated, respectively, with ranks varying between one and P. Each part of the identifier then takes a particular value.

The transmission method 100 then includes, for at least one part of rank which is greater than or equal to two, a determination (102) of an encryption key according to the values of the parts of preceding rank.

The transmission method 100 then includes an encryption (103) of said part with the encryption key thus determined. The encryption is performed according to a symmetric key encryption protocol 40.

The transmission method 100 then includes a determination 104 of the encrypted identifier 31 from the encrypted part(s) thus obtained.

Finally, the transmission method 100 includes a formation 105 of the message to be transmitted from the encrypted identifier, as well as a transmission 106 of the message to the receiver device 20 using the communication module 13.

With such arrangements, the receiver device will be able to discover, as the identifier is decrypted, which encryption keys to use in order to completely decrypt the identifier. Indeed, it is sufficient for the receiver device 20 to know how to decrypt the part (encrypted or not) of rank one in order to then be able to successively determine the encryption keys which must be used to decrypt the encrypted parts of rank which is greater than or equal to two.

In the rest of the description, it is considered by way of non-limiting example that all parts of rank greater than or equal to two are encrypted. However, nothing prevents that, in variants, only some of the parts of rank two to P are encrypted.

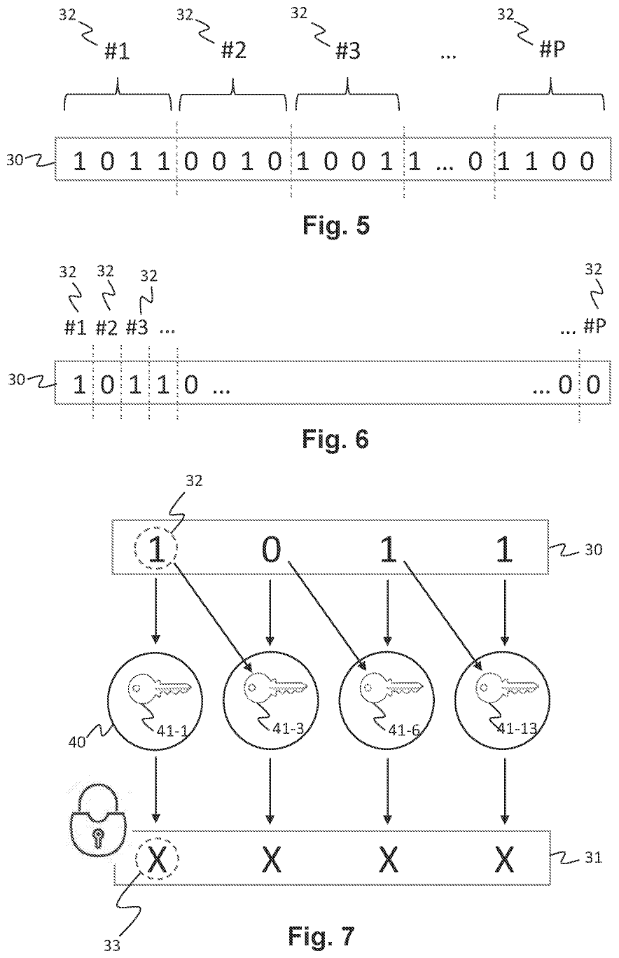

In the considered example, and as illustrated in FIG. 5, the identifier is encoded on a bit field. If N is the number of bits used to encode an identifier 30, a value taken by the identifier 30 is a value comprised between 0 and (2^{N}−1). For example, the identifier 30 includes thirty-two bits (N=32). In the division step 101, the identifier is divided into P parts 32 (P is the number of parts into which the identifier is split), and each part 32 of the identifier 30 can then for example be encoded on Nₖ bits, where Nₖ is a positive integer number strictly less than N and k is an index of said part varying between one and P (1≤k≤P). In the example illustrated in FIG. 5, each part 32 includes four bits, in other words Nₖ is worth four (Nₖ=4) regardless of the value of the index k. It should be noted, however, that there is no requirement that all parts 32 have the same size.

In the example illustrated in FIG. 5, the part 32 of rank one takes the value 0b1011 (the term “0b” indicates the binary representation, that is to say a base notation 2). The part 32 of rank two takes the value 0b0010. The part 32 of rank three takes the value 0b1001. Part 32 of rank P takes the value 0b1100.

In particular implementations, each part 32 includes a single bit. The identifier 30 is then divided into N parts 32 (there is then P=N). Such arrangements allow maximising the number P of used parts 32 and therefore reinforcing the security of the encryption.

In the example illustrated in FIG. 6, the part 32 of rank one takes the value 0b1, the part 32 of rank two takes the value 0b0, the part 32 of rank three takes the value 0b1, the part 32 of rank four takes the value 0b1, . . . , the part of rank P takes the value 0b0.

FIGS. 7, 9 and 10 illustrate by way of example and to simplify the unrealistic case where the identifier 30 of the transmitter device 10 is encoded by a field of four bits (N=4). As illustrated in FIG. 7, in the considered example the identifier 30 takes the binary value 0b1011. The identifier 30 has been divided (at the division step 101) into four parts each including a single bit (P=4). The part 32 of rank one takes the value 0b1, the part 32 of rank two takes the value 0b0, the part 32 of rank three takes the value 0b1, the part 32 of rank four takes the value 0b1. FIG. 7 schematically represents an example of implementation of the steps of encryption 103 of the parts 32 of the identifier 30 and of determination 104 of an encrypted identifier 31 in the transmission method 100 according to the invention.

In the example considered and illustrated in FIG. 7, the first part (i.e. the rank one part) is encrypted with the encryption protocol 40 using an encryption key 41-1. This encryption key 41-1 is used by all transmitter devices 10 of the communication system (or at least by a subset of the transmitter devices 10 of the communication system, for example if only the transmitter devices 10 of said subset use the transmission method 100 according to the invention) to encrypt the first part of the identifier 30. This encryption key 41-1 is also known by the receiver devices 20 of the communication system. Such arrangements allow a receiver device 20 to know how to decrypt the first part of an encrypted identifier 31 received in a message.

An encryption key 41-3 is determined from the value 0b1 of the first part 32 of the identifier 30. This encryption key 41-3 is used to encrypt, with the encryption protocol 40, the second part 32 of the identifier 30 (that is to say the part of rank two).

An encryption key 41-6 is determined from the respective values (0b1 and 0b0) of the first two parts 32 of the identifier 30. This encryption key 41-6 is used to encrypt, with the encryption protocol 40, the third part 32 of the identifier 30 (that is to say the part of rank three).

An encryption key 41-13 is determined from the respective values (0b1, 0b0 and 0b1) of the first three parts 32 of the identifier 30. This encryption key 41-13 is used to encrypt, with the encryption protocol 40, the fourth part 32 of the identifier 30 (that is to say the part of rank four).

It should be noted that, in the drawings, the reference numeral 41 generally relates to an encryption key used by a symmetric key encryption protocol 40. A reference 41-j represents a particular encryption key of index j.

An encrypted identifier 31 is then obtained by concatenating the encrypted parts 33 which are successively obtained.

It should be noted that there is no requirement that an encrypted part 33 has the same size as the corresponding unencrypted part. Also, the encrypted parts 33 do not necessarily all have the same size. There is also no requirement that the same encryption protocol 40 is used for the encryption of the different parts 32 of the identifier 30.

Also, and as has been described with reference to FIGS. 1 and 2, each part 32 can be encrypted according to the encryption protocol 40 depending, on the one hand, on the encryption key 41 and, on the other hand, on other parameters such as for example the useful data contained in the message, or a sequence number from a message counter for which a synchronisation is maintained between the transmitter device and the receiver device.

In particular embodiments of the transmission method 100 according to the invention, rather than encrypting the first part of the identifier with an identical encryption key for all transmitter devices 10, it is possible not to encrypt the first part of the identifier (only the parts of rank 2 to P are encrypted). Such arrangements allow a receiver device 20 not to have to decrypt the first part of an encrypted identifier 31 received in a message. A part of rank which is greater than or equal to two can then be decrypted using an encryption key determined depending on the values of the previous decrypted parts (or not encrypted if it is the part of rank one).

In general, considering that the identifier of a transmitter device is divided into P parts, each part can take Mₖ distinct values (for example, if the part of index k includes Nₖ bits, then Mₖ=2^{Nk}) and that D is the number of different values that can be taken by an identifier (D=2^{N} with N=Σₖ₌₁^{k=P} Nₖ), then the encryption key associated with the part of rank two is shared between D/M₁ transmitter devices, the encryption key associated with the part of rank three is shared between D/(M₁×M₂) transmitter devices, . . . , the encryption key associated with the part of rank k is shared between D/(M₁×M2× . . . ×M₍ₖ₋₁₎) transmitter devices, . . . , the encryption key associated with the part of rank P is shared between D/(M₁×M2× . . . ×M₍ₖ₋₁₎× . . . ×M_{(P-1)}) transmitter devices.

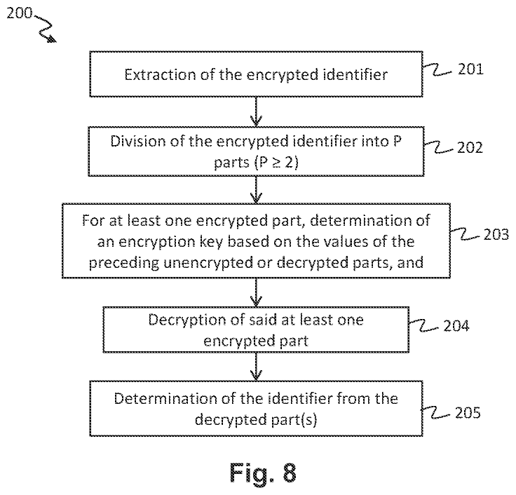

FIG. 8 represents the main steps of a reception method 200 for receiving a message by a receiver device 20 originating from a transmitter device 10. The reception method 200 is implemented by the receiver device 20. For this purpose, and as illustrated in FIG. 3, the receiver device 20 includes a memory 21, one or more processors 22 and a communication module 23. A computer program is stored in a non-volatile manner in the memory 21 of the receiver device 20. The computer program includes a set of program code instructions which, when executed by the processor(s) 22, configure the processor(s) 22 to implement a reception method 200 according to the invention. Alternatively or in addition, the receiver device 20 includes one or more programmable logic circuits (FPGA, PLD, etc.), and/or one or more specialised integrated circuits (ASIC), and/or a set of discrete electronic components, etc., adapted to implement all or part of the steps of the reception method 200 according to the invention. In other words, the receiver device 20 includes means which are software configured (specific computer program product) and/or hardware configured (FPGA, PLD, ASIC, discrete electronic components, etc.) to implement the steps of the reception method 200 according to the invention.

As illustrated in FIG. 8, the reception method 200 includes an extraction 201 of the encrypted identifier 31 of the message which was received using the communication module 23.

The reception method 200 then includes a division 202 of the encrypted identifier 31 into the P parts.

The reception method 200 then includes, for at least one encrypted part 33 of rank greater than or equal to two, a determination 203 of an encryption key 41 depending on the values of the unencrypted or decrypted parts of preceding rank.

The reception method 200 then includes a decryption 204 of said encrypted part 33. The decryption is performed according to the symmetric key encryption protocol 40 which was used by the transmission method 100 for transmitting the message.

Finally, the reception method 200 includes a determination 205 of the identifier 30 of the transmitter device 10 from the decrypted part(s) thus obtained.

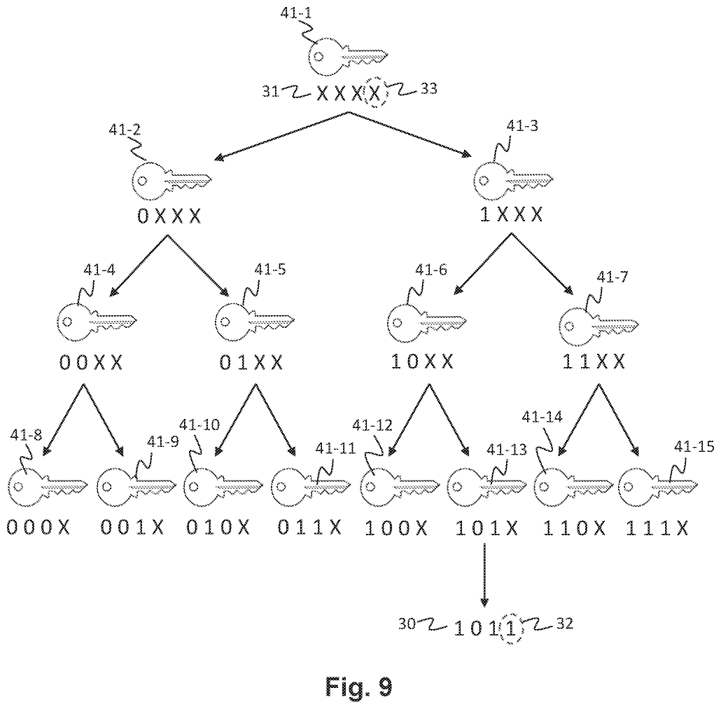

FIG. 9 schematically represents the encryption keys 41-1 to 41-15 determined respectively depending on the values of the parts 32 of an identifier. In the example which is considered and illustrated in FIG. 9, the key 41-2 is associated with the value 0b0 of the part of rank one of the identifier, the key 41-3 is associated with the value 0b1 of the part of rank one of the identifier, the key 41-4 is associated with the value 0b00 taken by the parts of rank one to two of the identifier, the key 41-5 is associated with the value 0b01 taken by the parts of rank one to two of the identifier, the key 41-6 is associated with the value 0b10 taken by the parts of rank one to two, the key 41-7 is associated with the value 0b11 taken by the parts of rank one to two, the key 41-8 is associated with the value 0b000 taken by the parts of rank one to three, the key 41-9 is associated with the value 0b001 taken by the parts of rank one to three, the key 41-10 is associated with the value 0b010 taken by the parts of rank one to three, the key 41-11 is associated with the value 0b011 taken by the parts of rank one to three, the key 41-12 is associated with the value 0b100 taken by the parts of rank one to three, the key 41-13 is associated with the value 0b101 taken by the parts of rank one to three, the key 41-14 is associated with the value 0b110 taken by the parts of rank one to three, the key 41-15 is associated with the value 0b111 taken by the parts of rank one to three.

The encryption key 41-1 allows decrypting the part of rank one of the identifier 30 (in the considered example, this encryption key 41-1 is known a priori to the receiver device 20 and allows decrypting the part of rank one of an identifier regardless of the transmitter device 10 having sent the message 15).

The encryption keys 41-2 and 41-3 allows decrypting the part of rank two of the identifier. They are determined depending on the value of the part of rank one of the identifier.

The encryption keys 41-4 to 41-7 allows decrypting the part of rank three of the identifier. They are determined depending on the values of the parts of rank one and two of the identifier.

The encryption keys 41-8 to 41-15 allows decrypting the part of rank four of the identifier. They are determined depending on the values of the parts of rank one to three of the identifier.

In particular implementations, the encryption keys 41-1 to 41-15 determined depending on the values of the parts 32 of an identifier 30 are all different from each other. Such arrangements allow reinforcing the security of the encryption of the identifier. In general, if an identifier is encoded on N bits, where all parts of an identifier are encrypted, and where each part corresponds to a bit of the identifier, then the same encryption key 41 which allows decrypting a part of rank of index k is shared by 2^{N-k+1} transmitter devices. The number of encryption keys which must be stored by a transmitter device 10 to encrypt the identifier 30 thereof is equal to N (as many encryption keys as parts into which the identifier is divided). The number of encryption keys that must be stored by a receiver device 20 in order to be able to decrypt an identifier included in a message 15 transmitted by any transmitter device 10 is equal to Σⱼ₌₀^{N-1} 2^{j}=(2^{N}−1). With an identifier encoded on thirty-two bits (N=32), more than four billion (2³²=4,294,967,296) transmitter devices can have a different identifier; a transmitter device must store at most thirty-two encryption keys (i.e. a memory occupation of five hundred and twelve bytes (512 B) for encryption keys of 128 bits in length); and a receiver device must store at most 2³²−1=4,294,967,295 encryption keys (which represents a memory occupancy of sixty-four gibibytes (64 GiB) for encryption keys of 128 bits in length). It is also interesting to note that only two different transmitter devices can have the same set of encryption keys.

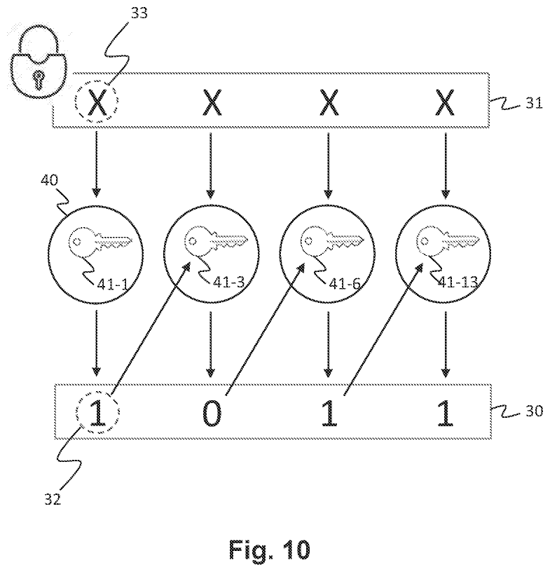

FIG. 10 schematically represents an example of implementation of the steps of decrypting 204 the encrypted parts 33 and of determining 205 the identifier 30 in the reception method 200 according to the invention, for an identifier which has been encrypted as in FIG. 7.

The encrypted part 33 of rank one is decrypted according to the encryption protocol 40 from the encryption key 41-1 which is common to all transmitter devices 10 and which is known a priori by the receiver device 20. Possibly, other parameters such as for example the useful data or a sequence number contained in the message can be used to decrypt the message. The receiver device 20 can then determine, from the value 0b1 of the first decrypted part 32, the encryption key 41-3 which must be used to decrypt the part of rank two. In the considered example, the value of the decrypted part of rank two is 0b0. The receiver device 20 can then determine, from the value 0b10 taken by the first two decrypted parts, the encryption key 41-6 which must be used to decrypt the part of rank three. In the considered example, the value of the decrypted part of rank three is 0b1. The receiver device 20 can then determine, from the value 0b101 taken by the first three decrypted parts, the encryption key 41-13 which must be used to decrypt the part of rank four. In the considered example, the value of the decrypted part of rank four is 0b1.

The identifier 30 of the transmitter device 10 which transmitted the message 15 is then obtained by concatenating the decrypted parts which are successively obtained. The value of identifier 30 is 0b1011.

The above description clearly illustrates that, through its different features and their advantages, the present invention achieves the set objectives. In particular, the invention allows encrypting, with a very satisfactory level of security, the identifier of a transmitter device with a symmetric key encryption protocol. A transmitter device which receives a message containing an encrypted identifier is capable of decrypting the identifier.

It should be noted that the implementations and embodiments considered above have been described by way of non-limiting examples, and that other variants are therefore possible.

In particular, and as previously mentioned, is not necessary for all parts of an identifier to be encrypted. The size of a part, encrypted or not, can vary according to the implementations. Different symmetric key encryption protocols can be used, and the choice of a particular encryption protocol is only one variation of the invention.

The invention has been described by considering the communication systems for connected objects of the IoT or M2M type. However, nothing excludes, following other examples, considering other communication systems.

1-22. (canceled)

23. A transmission method for transmitting a message, by a transmitter of a communication system, to a receiver of the communication system, the transmission method comprising:
a division of an identifier of the transmitter into P parts, P being an integer number at least equal to two, the P parts being ordered and associated, respectively, with ranks varying between one and P, the P parts comprising a part of rank one and P−1 parts, each of the P−1 parts being of rank two or higher, up to rank P, each of the P parts having a value;
for at least one part of rank which is greater than or equal to two, a determination of an encryption key depending on the values of the parts of preceding rank and an encryption of said at least one part with the encryption key thus determined, the encryption being performed according to a symmetric key encryption protocol, the encryption providing an encrypted part;
a determination of an encrypted identifier based on the encrypted part thus obtained;
a formation of the message to be transmitted based on the encrypted identifier; and
a transmission of the message.

24. The transmission method of claim 23, wherein the encryption is performed on all parts of rank greater than or equal to two, thereby obtaining P−1 encryption keys and P−1 encrypted parts of rank two to P.

25. The transmission method of claim 24, wherein the determination of the encrypted identifier comprises an encryption of the part of rank one with an identical encryption key for a plurality of transmitters of the communication system, thus obtaining an encrypted part of rank one; and a concatenation of the encrypted part of rank one to P.

26. The transmission method of claim 24, wherein the determination of the encrypted identifier comprises a concatenation of the part of rank one with the encrypted part of rank two to P, the part of rank one being unencrypted.

27. The transmission method of claim 23, wherein each of the P parts comprises a single bit of a bit field corresponding to the identifier of the transmitter.

28. The transmission method of claim 23, wherein the encryption is performed on at least two parts, thus obtaining at least two encryption keys, and the encryption keys are all different from each other.

29. A computer-readable storage medium comprising a set of program code instructions executable by a processor to implement the transmission method of claim 23.

30. A transmitter of a communication system to transmit a message to a receiver of the communication system, the transmitter comprising a processor configured to:
divide an identifier of the transmitter into P parts, P being an integer number at least equal to two, the P parts being ordered and associated respectively with ranks varying between one and P, and the P parts comprising a part of rank one and P−1 parts, each of the P−1 parts being of rank two or higher, up to rank P, each of the P parts having a value;
for at least one part of rank which is greater than or equal to two, determine an encryption key depending on the values of the parts of preceding rank, and encrypt said at least one part with the encryption key thus determined, the encryption being performed according to a symmetric key encryption protocol, the encryption providing an encrypted part;
determine an encrypted identifier based on the encrypted part thus obtained;
form a message to be transmitted based on the encrypted identifier; and
transmit the message to the receiver.

31. The transmitter of claim 30, wherein the processor is configured to encrypt all parts of rank greater than or equal to two, thereby obtaining P−1 encryption keys and P−1 encrypted parts of rank two to P.

32. The transmitter of claim 31, wherein the processor determines the encrypted identifier by encrypting the part of rank one with an identical encryption key of a plurality of transmitters of the communication system, thereby obtaining an encrypted part of rank one; and wherein the processor concatenates the encrypted part of rank one to P.

33. The transmitter of claim 31, wherein the processor determines the encrypted identifier by concatenating the part of rank one with the encrypted parts of rank two to P, the part of rank one being unencrypted.

34. The transmitter of claim 30, wherein each of the P parts comprises a single bit of a bit field corresponding to the identifier of the transmitter.

35. The transmitter of claim 30, wherein the processor is configured to encrypt at least two parts, thereby obtaining at least two encryption keys, and the encryption keys are all different from each other.

36. A reception method for receiving, by a receiver of a communication system, a message transmitted by a transmitter of the communication system in accordance with the transmission method of claim 23, the reception method comprising:
an extraction of the encrypted identifier of the message received;
a division of the encrypted identifier into the P parts, at least one part of rank two or higher being the encrypted part;
for the encrypted part, a determination of the encryption key depending on the values of unencrypted or previously decrypted parts of preceding rank, and a decryption of the encrypted part with the encrypted key thus determined, the decryption being performed according to the symmetric key encryption protocol used by the transmission method for transmitting the message, the decryption providing a decrypted part; and
a determination of the identifier of the transmitter based on the decrypted part thus obtained.

37. The reception method of claim 36, wherein the decryption is performed on all parts of rank greater than or equal to two, thereby obtaining the P−1 encryption keys and P−1 decrypted parts of rank two to P.

38. The reception method of claim 37, wherein the part of rank one of the identifier of the transmitter being encrypted by the transmission method with an identical encryption key for a plurality of transmitters of the communication system to provide an encrypted part of rank one; and wherein the determination of the identifier of the transmitter comprises: a decryption of the encrypted part of rank one with said identical encryption key, thereby obtaining a decrypted part of rank one; and a concatenation of the decrypted part of rank one to P.

39. The reception method of claim 37, wherein the part of rank one of the identifier of the transmitter being transmitted unencrypted; and wherein the determination of the identifier of the transmitter comprises a concatenation of the unencrypted part of rank one with the decrypted part of rank two to P.

40. A computer-readable storage medium comprising a set of program code instructions executable one or more processors to implement the reception method of claim 36.

41. A receiver of a communication system to receive a message transmitted by a transmitter of the communication system in accordance with the transmission method of claim 23, the receiver comprises a processor configured to:
extract the encrypted identifier of the message received;
divide the encrypted identifier into P parts, at least one part of rank two or higher being the encrypted part;
for the encrypted part, determine the encryption key depending on the values of unencrypted or previously decrypted parts of preceding rank, and decrypt the encrypted part with the encryption key thus determined, the decryption being performed according to the symmetric key encryption protocol used by the method for transmitting the message, the decryption providing a decrypted part; and
determine the identifier of the transmitter based on the decrypted part thus obtained.

42. The receiver of claim 41, wherein the processor is configured to decrypt all parts of rank greater than or equal to two, thus obtaining the P−1 encryption keys and P−1 decrypted parts of rank two to P.

43. The receiver of claim 42, wherein the part of rank one of the identifier of the transmitter being encrypted by the transmission method with an identical encryption key for a plurality of transmitters of the communication system; and wherein the processor is configured to determine the identifier of the transmitter by: decrypting the encrypted part of rank one with said identical encryption key, thereby obtaining a decrypted part of rank one; and concatenating the decrypted part of rank one to P.

44. The receiver of claim 42, wherein the part of rank one of the identifier of the transmitter being transmitted unencrypted; and wherein the processor concatenates the unencrypted part of rank one with the decrypted part of rank two to P, to determine the identifier of the transmitter.
